(19) United States
(12) Patent Application Publication
(10) Pub. No.: US 2023/0281202 A1
(43) Pub. Date: Sep. 7, 2023

(54) SYSTEM AND METHOD FOR GENERATING ONE OR MORE EMBEDDINGS OF ONE OR MORE ENTITIES

(71) Applicant: HireTeamMate Incorporated, Mountain View, CA (US)

(72) Inventor: Yu ZHOU, Springfield, NJ (US)

(21) Appl. No.: 17/686,896

(22) Filed: Mar. 4, 2022

(51) Int. Cl. G06F 16/2455; G06F 16/2457

(52) U.S. Cl. CPC G06F 16/24564; G06F 16/24578

(57) ABSTRACT

A system for generating one or more embeddings of one or more entities is provided. The system is configured to input a set of data and corresponding set of attributes for a pair of entities into a rule-based model. The rule-based model is used to determine one or more similar data in the set of data and a similarity score for the pair of entities based on corresponding one or more attributes of the one or more similar data. The one or more similar data and the similarity score identify a similarity between the pair of entities. Further, a collaborative pair is generated for the pair of entities based on the one or more similar data and the similarity score. The generated collaborative pair and the similarity score are inputted to an embedding model that generates one or more embeddings for the entities.

### FIELD

The present disclosure generally relates to data handling and management in a platform, and more particularly relates to systems and methods for generating one or more embeddings of one or more entities in the platform.

### BACKGROUND

In various data handling and database applications, identification of entities that are similar may be important for numerous reasons. Such reasons may include, efficient data storage, faster data processing and avoiding data redundancy. One such data handling related application is a talent acquisition application. In the talent acquisition application, the identification of similar entities, such as company entities or job candidate entities may be crucial for a job recruitment task. Typically, a recruiter or a talent management professional may perform data mining for checking if a candidate’s profile matches with each company and performing the job recruitment. The data mining process extracts and discovers patterns in a large data set stored in a database. The large data set comprises multiple candidate profiles, multiple companies, or the like. In particular, the recruiter may use the data mining process to identify important features of each candidature, such as candidate’s qualification, candidate’s skills, candidate’s designation, candidate’s years of experience, candidate’s preference of work location, or the like, which may be laborious for the recruiter to find suitable competencies. The recruiter may also be required to check in their database to identify similar companies to perform job recruitment of similar candidates.

However, accessing such large amount of data from the database repeatedly and checking for the similar entities for job recruitment, may consume time and thereby affect the overall efficiency of the hiring process. The job recruitment may be performed using machine learning solutions that are capable of suggesting pertinent jobs or candidates based on the behavior and needs of candidates and on requirements of employers. However, processing such large amount of data for the job recruitment may consume storage and computing resources, which may not be efficient and feasible.

Thus, there is a need to overcome the challenges of inefficient, outdated, less secure and inaccurate candidate data management technologies, in order to provide high quality, accurate, secure, and reliable data for talent management professionals. More specifically, there is need to provide a technical solution to process the large amount of data for the job recruitment, in an efficient and feasible manner.

### SUMMARY

It is an objective of some of the example embodiments disclosed herein to provide efficient solutions to the problems and challenges discussed above. More specifically, it is an objective of the various embodiments disclosed herein to provide efficient processing of a large amount of data for generating embeddings for entities of talent management applications.

Various embodiments disclosed herein provide effective data management in a data platform, such as a talent data management platform. The platform provides efficient, secure, accurate and productive data management by using up-to-date and targeted computational system, based on advanced computing techniques such as AI, machine learning, and rule-based processing.

Some embodiments provide methods and systems for generating embeddings for one or more entities in a data management platform, such as a talent acquisition platform, so as to provide a job recommendation of similar company entities to a candidate job seeker. Each of the embeddings is a feature vector in a low-dimensional space that describes an entity, such as a customer of the talent acquisition platform. To that end, it is another objective of some of the example embodiments disclosed herein to identify similarity between two entities using a rule-based model. Further, a collaborative pair for the two entities is generated based on the identified similarity between the two entities. The collaborative pair may include similar data, such as similar entity type of the two entities, a similar relationship corresponding to a user entity of each of the two entities, or the like. Furthermore, the collaborative pair is used for generating the one or more embeddings. In some embodiments, the embeddings are used for generating a job recommendation task for a user job profile data.

In one aspect, a system for generating one or more embeddings of one or more entities is disclosed. The system comprises: a memory configured to store computer-executable instructions and at least one processor configured to execute the computer-executable instructions. The computer executable instructions configured to: input a set of data and corresponding set of attributes for a pair of entities into a rule-based model. The computer executable instructions further configured to determine, using the rule-based model, one or more similar data in the set of data and a similarity score for the pair of entities based on corresponding one or more attributes of the one or more similar data. The one or more similar data and the similarity score identify a similarity between the pair of entities. The computer executable instructions are further configured to generate, using a collaborative filtering model, a collaborative pair for the pair of entities based on the one or more similar data and the similarity score. The computer executable instructions configured to input the generated collaborative pair and the similarity score to an embedding model. The computer executable instructions further configured to generate one or more embeddings for the pair of entities based on the embedding model.

In some example embodiments, the set of data comprises an entity name, an entity type, an entity strength, an entity location, and a set of entity services and products of each corresponding pair of entities. The set of attributes comprises one or more values of each of the set of data. The set of data and the corresponding set of attributes are inputted to the rule-based model that includes a set of rules for identifying one or more similar data in the set of data. The set of rules may identify the similar data based on similar attributes in the set of attributes. The rule-based model also computes a similarity score for the two company entities. The similar data and the similarity score together identify the similarity between the two entities.

Additionally, the system is configured to perform a verification of the one or more similar data and the similarity score based on a manual verification. In some cases, the system may determine one or more incorrect data in the identified one or more similar data and the similarity score based on the manual verification. The one or more incorrect data correspond to dissimilarity in a least the one or more similar data and the similarity score. For instance, there may be dissimilar data in the identified similar data and a user may identify the dissimilar data as incorrect data. The user may provide inputs to perform a correction of the incorrect data in the similar data. For instance, the user may provide inputs to remove the dissimilar data in the identified similar data. The similarity score may also be corrected based on the correction of the incorrect data. Additionally, the system is configured to update the rule-based model based on the correction of the similar data and the similarity. The rule-based model is updated to provide accurately identify similar data and similarity score between the two entities.

Further, the one or more similar data and the similarity score are inputted to a collaborative filtering model. The collaborative filtering model generates a collaborative pair for the two entities based on the identified similar data and the similarity score. The collaborative pair may include a similar relationship of a user entity associated with each of the two entities. For instance, the user entity may be a previous employee of one entity that is currently employed to the other entity. The user entity may be accessed from a database of the system that stores corresponding user entity data. The user entity data may include one or more user data that match with corresponding one or more data in the set of data of the two entities.

Further, the system is configured to generate one or more embeddings for the entities based on the collaborative pair. To that end, the collaborative pair is inputted to an embedding model for generating the one or more embeddings for the one or more entities. The embedding model is trained to map features of the collaborative pair into one or more embeddings. Each of the embeddings corresponds to a representation of vectors that encode meaning or content of the collaborative pair such that the collaborative pair are closer in a vector space that are expected to be similar in content. The generated one or embeddings may be stored in the database of the system. Such embeddings may improve performance in various tasks of the talent acquisition platform, such as a job recruitment task of the talent acquisition platform.

To that end, in some additional embodiments, the system is configured to receive a user profile data for the job recruitment task. The system is configured to determine a matching embedding from the generated one or more embeddings for the user profile data. The user profile data may include user’s name, user’s designation, user’s qualification, user’s experience, user’s previous and current employer or company information, or the like that may be processed by the system to determine the matching embedding for the user profile data. After determining the matching embedding, a recommendation response is generated for the user profile data. The recommendation response may comprise one or more entities suitable for the user profile data.

In another aspect, a method for generating one or more embeddings of one or more entities is disclosed. The method comprises inputting a set of data and corresponding set of attributes for a pair of entities into a rule-based model. The method additionally comprises determining, using the rule-based model, one or more similar data in the set of data and a similarity score for the pair of entities based on corresponding one or more attributes of the one or more similar data. The one or more similar data and the similarity score identify a similarity between the pair of entities. Further, using a collaborative filtering model a collaborative pair for the pair of entities is generated based on the one or more similar data and the similarity score. The generated collaborative pair and the similarity score are inputted to an embedding model. The method further comprises generating one or more embeddings for the pair of entities based on the embedding model based on the embedding model.

In yet another aspect, a computer program product comprising a non-transitory computer readable medium having stored thereon computer executable instructions is provided. The computer executable instructions, when executed by at least one processor, cause the at least one processor to carry out operations for generating one or more embeddings of one or more entities, the operations comprising: inputting a set of data and corresponding set of attributes for a pair of entities into a rule-based model; determining, using the rule-based model, one or more similar data in the set of data and a similarity score for the pair of entities based on corresponding one or more attributes of the one or more similar data, wherein the one or more similar data and the similarity score identify a similarity between the pair of entities; generating, using a collaborative filtering model, a collaborative pair for the pair of entities based on the one or more similar data and the similarity score; inputting the generated collaborative pair and the similarity score to an embedding model; and generating one or more embeddings for the pair of entities based on the embedding model.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described example embodiments of the invention in general terms, reference will now be made to the accompanying drawings, which are not necessarily drawn to scale, and wherein:

FIG. 1 illustrates a block diagram showing a network environment of a system for managing data in a data management platform, in accordance with one or more example embodiments;

FIG. 2 illustrates a block diagram of the data management platform, in accordance with one or more example embodiments;

FIGS. 3A-3B collectively illustrates a flowchart of a method for generating one or more embeddings of one or more entities in the data management platform of FIG. 2, in accordance with one or more example embodiments;

FIG. 4 illustrates a tabular representation depicting a set of data and corresponding set of attributes for a pair of entities, in accordance with one or more example embodiments;

FIG. 5 illustrates a tabular representation depicting one or more similar data and a similarity score for the pair of entities, in accordance with one or more example embodiments;

FIG. 6 illustrates a graphical user interface (GUI) depicting a verification of the one or more similar data and the similarity score, in accordance with one or more example embodiments;

FIG. 7 illustrates a schematic block diagram for generating one or more embeddings by an embedding module, in accordance with one or more example embodiments;

FIG. 8 illustrates a GUI depicting a user profile data and a recommendation response for a job recruitment, in accordance with one or more example embodiments;

FIG. 9 illustrates a method flow diagram for generating one or more embeddings of one or more entities, in accordance with one or more example embodiments; and

FIG. 10 illustrates a block diagram of a computing system used for implementation of the system discussed in previous figures for data management, in accordance with one or more example embodiments.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses, systems, and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (for example, volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

A system, a method, and a computer program product are provided for generating one or more embeddings of one or more entities in a data management platform. The data management platform may be a talent acquisition platform and the data may be talent data related to the one or more entities, (e.g., company entities) for talent acquisition of job candidates. The talent acquisition may refer to job recruitment for organizations, institutions, healthcare facilities, government bodies, and the likes in any industry. The data management platform may be accessed by a customer, such as talent management professional, for scouting for candidates for their organization, and also for storing candidate data for employees in their own organization or job seeker candidates. The customer in this manner may be embodied as a business customer or an organization, desirous of managing their talent data using the data management platform.

The systems and methods disclosed herein provide efficient, reliable, secure, and accurate data management for the customers of the data management platform through generation of computationally efficient one or more embeddings for one or more entities. Further, some embodiments disclose generation of a recommendation of one or more entities corresponding to a job recruitment task for the customers based on the one or more embeddings. The one or more embeddings that encode similar contents of the one or more entities are generated in an efficient and feasible manner, while consuming lesser amount of computing and storage resources.

Various embodiments provide efficient methodologies and machine learning (ML) based models for generating the one or more embeddings for the one or more entities, helping them increase the productivity and efficiency of overall hiring processes. In some embodiments, the one or more embeddings may be stored and maintained in a database of the data management platform that may be accessed by the talent management professional when a user profile data is received for a job recruitment task. For the user profile data, a recommendation response that comprises one or more entities suitable for the user profile data is generated, which improves a hiring process as well as improves productivity for the talent management professional for performing the job recruitment task. Thus, the generation of the embeddings saves time and laborious effort of talent data management professionals for identifying relevant companies or jobs by the use of the systems and methods disclosed herein.

These and various other advantages of the systems and methods disclosed herein will be apparent from the detailed description provided herein, in conjunction with the various accompanying figures described below.

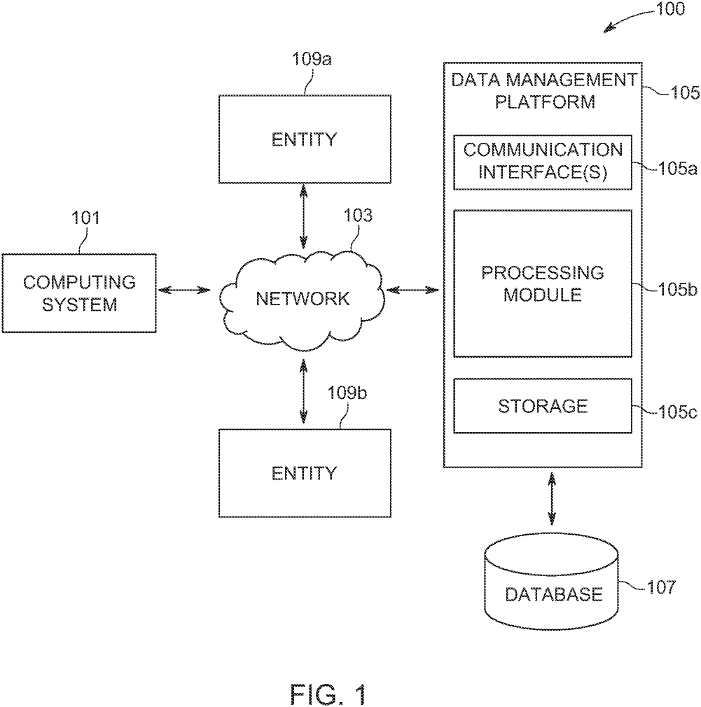

FIG. 1 illustrates a block diagram showing a network environment 100 of a system for generating one or more embeddings of one or more entities, such as an entity 109a and an entity 109b in a data management platform 105, in accordance with one or more example embodiments. The data management platform 105 may be embodied as the system which manages data related to various entities, such as company entities (e.g., clients or customers of the data management platform 105), candidates (such as job seekers), and talent management professionals. The network environment 100 comprises a computing system 101 in communication with the data management platform 105 over a communication network 103. The data management platform 105 may also be associated with an external database 107, which may store data about the entities, e.g., the entity 109a and the entity 109b.

The data management platform 105 may be embodied as a system for generating one or more embeddings for one or more entities, such as an entity 109a and an entity 109b. The one or more embeddings are generated using information of the entities 109a and 109b. The information may be stored in the database 107 that may be accessed via one or more communication interfaces, collectively referred to hereinafter as communication interface 105a of the data management platform 105. The communication interface 105a is configured for exchanging data with the computing system 101 and the database 107, and also other entities external to the data management platform 105. The communication interface 105a includes at least an input interface and an output interface (not shown). The input interface may be configured to receive an input data, such as the information of the one or more entities, such as the entities 109a and 109b. The information corresponding to the entities 109a and 109b may include a set of data and a corresponding set of attributes. The set of data comprises an entity name, an entity type, an entity strength, an entity location, and a set of entity services and products of each corresponding pair of entities 109a and 109b. The set of attributes comprises one or more values of each of the set of data.

The communication interface 105a may transmit the set of data and the corresponding set of attributes to a processing module 105b of the data management platform 105. The processing module 105b is configured to execute one or more computer executable instructions related to the generation of the one or more embeddings. The computer-executable instructions may be stored in a storage 105c, or a memory associated with the data management platform 105. The processing module 105b is configured to determine one or more similar data in the set of data and a similarity score for a pair of entities, such as the entities 109a and 109b using a rule-based model. The rule-based model may be stored in the form of computer-executable instructions in the storage 105c specific to implementation of the rule-based model, when required. In some embodiments, the rule-based model may be stored in a cloud computing-based server, a remote server, or a virtual server that may be different from but is associated with the data management platform 105.

The processing module 105b is further configured to determine a collaborative pair for the entities 109a and the 109b based on the one or more similar data and the similarity score. The collaborative pair includes a similar data between the entities 109a and 109b and may be generated using a collaborative filtering model. The collaborative filtering model may be stored in the form of computer-executable instructions in the storage 105c. In some embodiments, the collaborative filtering model may be stored in a cloud computing-based server, a remote server, or a virtual server that may be different from but is associated with the data management platform 105.

The collaborative pair may include at least a similar relationship of a user entity that is associated with each of the entities 109a and 109b, a similar entity type of the entities 109a and 109b. For instance, the similar relationship may correspond to a user that may be previously employed in one company entity, such as the entity 109a and the user may be currently employed in other company entity, such as the entity 109b.

In some embodiments, the collaborative pair may be generated upon successful verification of the one or more similar data and the similarity score. The one or more similar data and the similarity score may be verified based on a manual verification. For instance, a developer associated with the data management platform 105 may use verification tools for the verification of the one or more similar data and the similarity score. The verification may be performed via the application interface of the data management platform 105 using the computing system 101. In some cases, the developer may determine one or more dissimilar data in the identified one or more similar data. The determined one or more dissimilar data may impact the identified similarity score. To that end, the developer may provide inputs, such as inputs to remove the one or more dissimilar data and correct the one or more similar data and the similarity score. The corrected one or more similar data and the similarity score may be used for generating the collaborative pair.

Further, the processing module 105b is configured to generate the one or more embeddings based on the generated collaborative pair. The one or more embeddings include feature vectors represented in a low-dimensional space that describes the entities 109a and 109b are generated using an embedding model. The embedding model may be trained and stored in the storage 105c. In some embodiments, the embedding model may be stored in the form of computer-executable instructions in the storage 105c. In some other embodiments, the embedding model may be stored in a cloud computing-based server, a remote server, or a virtual server that may be different from but is associated with the data management platform 105. The one or embeddings may be used for a recommendation response in a job recruitment task of a user profile data. The recommendation response comprises one or more entities such as the entities 109a and 109b that are suitable for the user profile data.

The user profile data may be received from one or more sources such as from a user (e.g., a company or a job seeker), from a public forum, from a social networking portal, from a professional networking portal, from an email account, from direct submission by a candidate on the data management platform 105, from a web crawler that crawls public profiles on the web, and the like. In some embodiments, the user profile data is related to talent acquisition data managed by the data management platform 105 for one or more entities, such as the entities 109a and 109b that may be received from the user via an application interface of the data management platform 105 using the computation system 101.

The user profile data may be received in any of a number of possible formats, such as, in the form of a resume document, a job description related submission document, a form submitted on a job portal or website, a direct submission entry made on the data management platform 105 and the like. For example, a user may access their computing system 101 and using that, open or browse to a web page that may be the landing page for a website hosted by the data management platform 105. Then, the user selects an option for entering one or more user profile data, on the web page, and a form having different fields requiring user input may open up. These different fields may be configured for gathering information about the input profile, and may include fields such as name, years of experience, gender, technical skills, age, past organization, location, current salary, current designation/role, and the like. In some embodiments, the user may directly enter or upload a resume as the user profile data.

The user profile data may be parsed by the data management platform 105, to convert it to an acceptable format, such as a standardized user profile data format. The standardized profile format may include data fields such as name of a person, location of the person, designation of the person, working period of the person, education of the person, person information (such as contact details, age, gender etc.,), and the like. The standardized user profile data format provides identifiable information corresponding to the user profile data, which is represented by using one or more standardized fields. Each data in the user profile data is converted to a corresponding unique standardized profile by having its unique standardized profile data format. The user profile data may be parsed into the standardized profile data format by using data parsing technologies, such as a Named Entity Recognition (NER) model, sentiment analysis, text summarization, aspect mining, topic modeling, and the like, without deviating from the scope of the present disclosure.

The standardized profile data providing the identifiable information may be processed by the processing module 105b to determine a matching embedding from the one or more embeddings. In an example embodiment, the processing module 105b may use a search engine (not shown in FIG. 1) to determine the matching embedding from the one or more embeddings. The search engine may be hosted by the data management platform 105 that identifies, from the database 107, the matching embedding from the one or more embeddings. The processing module 105b then generates the recommendation response comprising the entities 109a and 109b suitable for the user profile data.

Thus, using the embodiments described above, the data management platform 105 embodies the system for generating the one or more embeddings for one or more entities, such as the entities 109a and 109b. The components described in the block diagram of the data management platform 105 may be further broken down into more than one component and/or combined together in any suitable arrangement. Further, it is possible that one or more components may be rearranged, changed, added, and/or removed without deviating from the scope of the present disclosure.

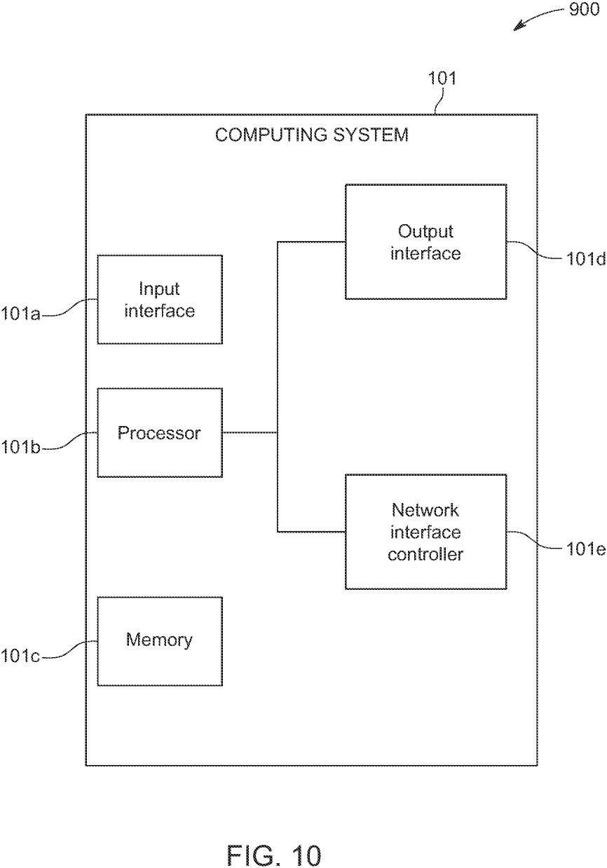

In an example embodiment, the data management platform 105 may be embodied in one or more of several ways as per the required implementation. For example, the data management platform 105 may be embodied as a cloud-based service, a cloud-based application, a cloud-based platform, a remote server-based service, a remote server-based application, a remote server-based platform, or a virtual computing system. As such, the data management platform 105 may be configured to operate inside the computing system 101. In some example embodiments, the computing system 101 may be any user accessible device such as a mobile phone, a smartphone, a portable computer, a personal computer, a laptop, a tablet, a phablet, a personal digital assistant (PDA), and the like. The computing system 101 may comprise a processor, a memory, and a communication interface. The processor, the memory, and the communication interface may be communicatively coupled to each other. The general architecture of the computing system 101 will be described in detail in FIG. 10. The computing system 101, the data management platform 105, and the database 107, may all be coupled communicatively via the communication network 103.

The communication network 103 may be wired, wireless, or any combination of wired and wireless communication networks, such as cellular, Wi-Fi, internet, local area networks, or the like. In one embodiment, the communication network 103 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof. The communication network 103 communicatively couples the computing system 101 used by the customer for accessing the services provided by the data management platform 105.

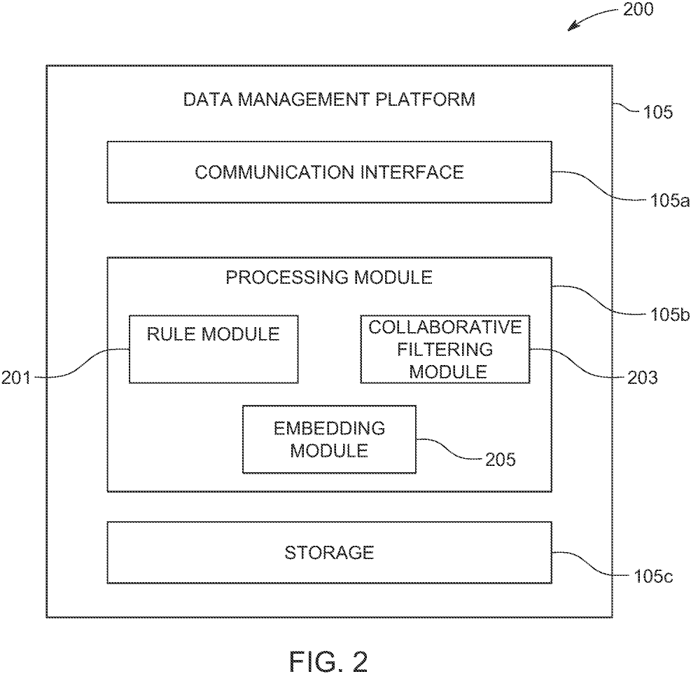

The processing module 105b that processes the set of data and the set of attributes for generating one or more embeddings for one or more entities is further described in FIG. 2.

FIG. 2 illustrates a block diagram 200 of the data management platform 105, in accordance with one or more example embodiments. As illustrated, the data management platform 105 comprises at least one processor, such as the processing module 105b, which further comprises a plurality of modules. This plurality of modules may include a rule module 201, a collaborative filtering module 203, and an embedding module 205. In some embodiments, the rule module 201, the collaborative filtering module 203 and the embedding module 205 may be stored in a cloud computing-based server, a remote server, or a virtual server that may be different from but is associated with the data management platform 105.

The processing module 105b may be embodied in a number of different ways. For example, the processing module 105b may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing module 105b may include one or more processing cores configured to perform independently. A multi-core processor may enable multiprocessing within a single physical package. Additionally or alternatively, the processing module 105b may include one or more processors configured in tandem via the bus to enable independent execution of instructions, pipelining and/or multithreading.

Additionally or alternatively, the processing module 105b may include one or more processors capable of processing large volumes of workloads and operations to provide support for big data analysis. In an example embodiment, the processing module 105b may be in communication with a memory, such as the storage 105c via a bus (not shown in FIG. 2) for passing information. The storage 105c may be non-transitory and may include, for example, one or more volatile and/or non-volatile memories. In other words, for example, the storage 105c may be an electronic storage device (for example, a computer readable storage medium) comprising gates configured to store data (for example, bits) that may be retrievable by a machine (for example, a computing device like the processing module 105b). The storage 105c may be configured to store information, data, content, applications, instructions, or the like, for enabling the data management platform 105 to carry out various functions in accordance with an example embodiment of the present disclosure. For example, the storage 105c may be configured to buffer input data for processing by the processing module 105b.

As exemplarily illustrated in FIG. 2, the storage 105c may be configured to store instructions for execution by the processing module 105b. As such, whether configured by hardware or software methods, or by a combination thereof, the processing module 105b may represent an entity (for example, physically embodied in circuitry) capable of performing operations according to an embodiment of the present disclosure while configured accordingly. Thus, for example, when the processing module 105b is embodied as an ASIC, FPGA or the like, the processing module 105b may be specifically configured hardware for conducting the operations described herein. Alternatively, as another example, when the processing module 105b is embodied as an executor of software instructions, the instructions may specifically configure the processing module 105b to perform the algorithms and/or operations described herein when the instructions are executed. However, in some cases, the processing module 105b may be a processor specific device (for example, a mobile terminal or a fixed computing device) configured to employ an embodiment of the present invention by further configuration of the processing module 105b by instructions for performing the algorithms and/or operations described herein. The processing module 105b may include, among other things, a clock, an arithmetic logic unit (ALU) and logic gates configured to support operation of the processing module 105b.

In some embodiments, the processing module 105b may be configured to provide Internet-of-Things (IoT) related capabilities to a user. In some embodiments, the user may be or correspond to a recruiter looking for suitable candidates. In other embodiments, the user may be an organization represented by its talent management team that has different talent management professionals accessing the data management platform 105. The data management platform 105 may be accessed using the communication interface(s) 105a. The communication interface 105a may provide an interface for accessing various features and data stored in the data management platform 105. For example, the communication interface 105a may comprise I/O interface which may be in the form of a GUI, a touch interface, a voice enabled interface, a keypad, a keyboard, a mouse, a display unit, a monitor, and the like. For example, the communication interface 105a may be a touch enabled interface of a server computer or a remote desktop that displays a web interface or web page for the data management platform 105.The data management platform 105 provides various functionalities for data management using the various modules 201-205 described below.

The various modules 201 - 205 of the processing module 105b, in conjunction with the storage 105c and communication interface 105a may provide capabilities and advantages to the data management platform 105 to generate the one or more embeddings for one or more entities, such as the entities 109a and 109b of the data management platform 105.

In some example embodiments, the communication interface 105a may be configured as an input interface configured to receive an input data related to the entities 109a and 109b that may be provided by a talent management professional. For instance, the talent management professional may enter or select corresponding names of the entities 109a and 109b via an application interface hosted by the data management platform using the computing system 101.

The input data is transmitted as input to the data management platform 105, where at the input interface associated with the communication interface 105a of the data management platform 105, the input data is received and forwarded to the processing module 105b. The input data may be in the form of a company profile of the customer entity, a document containing various fields of data for the customer entity, a job description for an opening at the entities 109a and 109b, and the like. The processing module 105b accesses a set of data and a corresponding set of attributes for the entities 109a and 109b from the database 107, upon receipt of the input data.

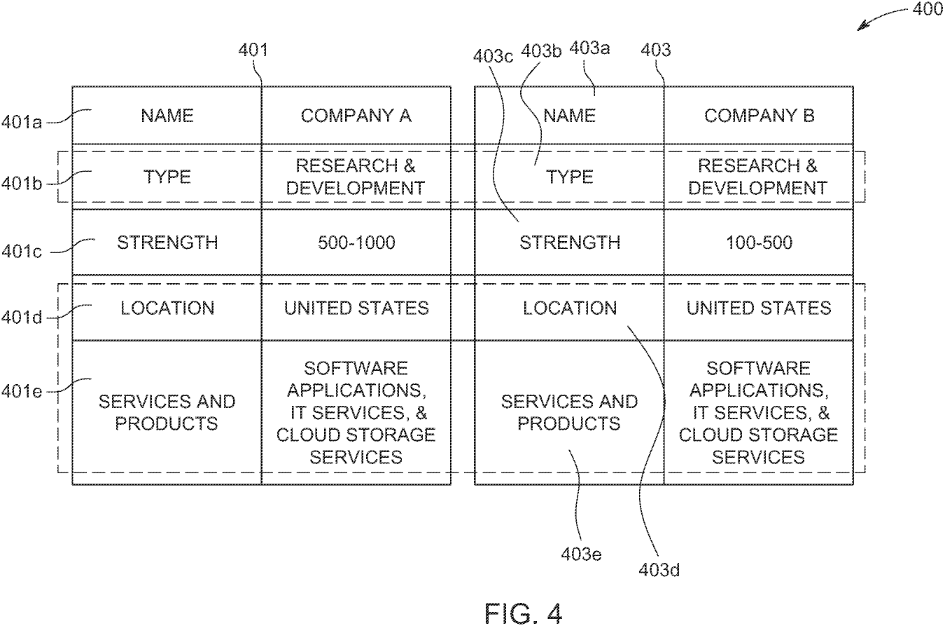

Further, the processing module 105b inputs the set of data and the set of attributes to the rule module 201. The set of data and set of attributes are described in FIG. 4. The rule module 201 that comprise a rule-based model identifies a similarity between the entities 109a and 109b. The rule-based model is a set of computer-executable rules for determining one or more similar data in the set of data of the pair of entities 109a and 109b. In some example embodiments, the one or more similar data are determined based on one or more similar attributes in the corresponding set of attributes of the pair of entities 109a and 109b. The rule module 201 also determines a similarity score based on the determined one or more similar data. The determined one or more similar data and the similarity score identify similarity between the entity 109a and the entity 109b.

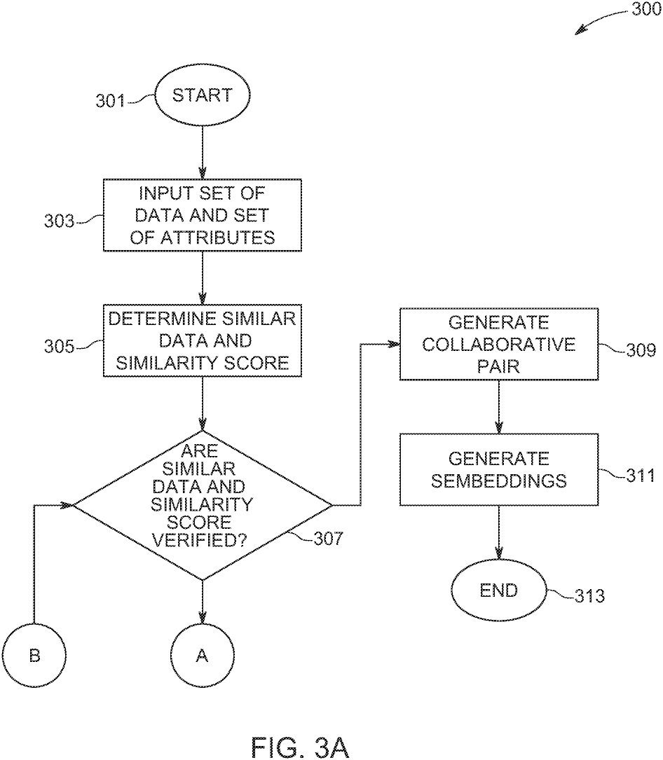

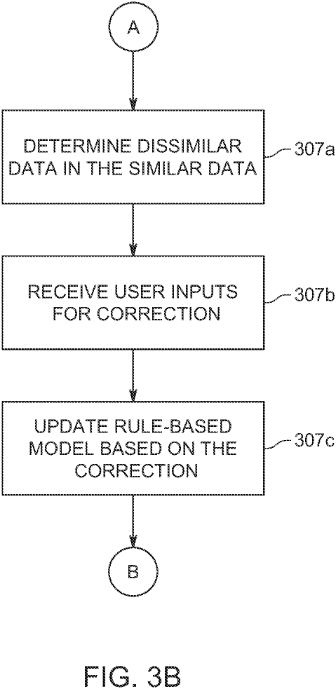

The set of computer-executable rules may include, for example, “if-then-else” based rules, which determines the one or more similar data in the set of data, and then computes a similarity score based on the determined one or more similar data. For example, one rule may be checking if type of the entity 109a and type of the entity 109b are same. The computer-executable rules may also include one or more of fuzzy logic rules, deterministic rules, probabilistic rules, or the like. The identifying of the one or more similar data from the set of data and the corresponding set of attributes, using the rule module 201 is further described in FIGS. 3A-3B.

Further, the determined one or more similar data and the similarity score are inputted to the collaborative filtering module 203. The collaborative filtering module 203 comprises a collaborative filtering model that generates a collaborative pair for the pair of entities 109a and 109b based on the one or more similar data and the similarity score. In particular, the entity 109a and the entity 109b are collaborated as the collaborative pair based on the one or more similar data and the similarity score. The collaborative filtering model uses the one or more similar data between the entities 109a and 109b to filter, i.e., predict collaborative pairs of entities, such as the entities 109a and 109b that are similar to each other. In some example embodiments, the collaborative filtering model may correspond to a Bayesian model, a clustering model, or the like.

Furthermore, the generated collaborative pairs and the similarity score are inputted to the embedding module 205. The embedding module 205 comprises an embedding model that generates one or more embeddings for the pair of entities 109a and 109b. In some embodiments, the embedding model is trained in an offline mode, that is before an actual input data is received and computations are performed by the rule module 201 and the collaborative filtering module 203. The trained embedding model generates one or more embeddings for the entities 109a and 109b. In particular, the trained embedding model maps discrete values of the one or more similar data into an embedding space to generate the one or more embeddings. The embedding space is a multi-dimensional space where values with similar function output, i.e., the entities 109a and 109b are close to each other. Each of the one or more embeddings is a vector representation of corresponding entity, such as the entity 109a and/or the entity 109b.

The embedding model may correspond to at least one of a word2vec embedding model and a two-tower deep learning model. The word2vec embedding model comprises two-layer neural networks that generate word embeddings from the one or more similar data. The two-tower deep learning model comprises two neural networks that generate the one or more embeddings. For instance, one neural network of the two-tower deep learning model maps query features corresponding to the one or more similar data of the entities 109a and 109b to a query embedding and other neural network of the two-tower deep learning model maps item features of the one or more similar data to an item embedding corresponding to the entities 109a and 109b.

Finally, the one or more embeddings are generated for the entities 109a and 109b using the embedding model. The generated one or more embeddings may be stored in the database 107. The one or more embeddings may be used for generating a recommendation response for a user profile data. In some embodiments, the communication interface 105a may receive the user profile data for a job recruitment task from the computing system 101. The communication interface 105a may transmit the user profile data to the processing module 105b. The processing module 105b determines a matching embedding from the one or more embeddings for the user profile data. The determined matching embedding may be used for generating a recommendation response that comprises a recommendation of one or more entities for the job recruitment task. The recommendation response may be transmitted to the computing system 101 via the output interface, which is the communication interface 105a. The recommendation response may be displayed on a user interface of the computing system 101.

In this manner, the data management platform 105 may enable a talent management professional to efficiently identify similar entities for a given input user profile data and make further processing decisions, such as hiring, sourcing, messaging candidates, updating their internal database, and the like.

The overall process for generating the one or more embeddings for the entities 109a and/or 109b by the processing module 105b, is described next with reference to FIGS. 3A-3B.

FIGS. 3A-3B collectively illustrate a flowchart of a method 300 for generating one or more embeddings of one or more entities in the data management platform 105, in accordance with one or more example embodiments.

In some embodiments, each operation described in each block of the method 300 may be implemented in the form of computer-executable instructions, which are stored in a memory, such as the storage 105c associated with the data management platform 105. Further, the computer-executable instructions when executed, cause the various operations of the method 300 to be performed by at least one processor, such as the processing module 105b associated with the data management platform 105. For example, the processing module 105b may be configured to carry out the operation associated with the generation of one or more embeddings for entities, such as the entities 109a and 109b.

The method 300 starts at step 301 when the communication interface 105a of the data management platform 105 receives an input data corresponding to the entities 109a and 109b that is transmitted from the computing system 101. For example, a user, such a talent management professional of a company entity accesses the computing system 101, such as a desktop, placed in their office and opens a website using a browser, the website corresponding to a URL for a server hosting the data management platform 105. In some embodiments, instead of the website accessed via a browser, the talent management professional may have a desktop client application running on their computing system 101, with which they access the data management platform 105. After accessing the data management 105 in any of these ways, the communication interface 105a of the data management platform 105 is provided to the user. For example a website landing page having GUI elements for input, or a GUI of the desktop client application may be displayed to the user.

Thereafter, the user accesses a GUI element for submitting the input data on the data management platform 105. For example, the user may upload company profiles of the company entities, which they want to use as the input data to generate the one or more embeddings. Alternatively, the user may select multiple fields displayed in the GUI to enter data about the input data. The multiple fields may be such as company name, company type, company location, company strength, services and products offered by the company, and the like of each of the company entities. The user may select these fields using various GUI elements such as forms, drop-down menus, radio buttons, filters, date range/calendar lists and the like. Using either type of submission, the input data may be received at the data management platform 105. After the selection of the fields, a set of data and corresponding set of attributes of the company entities (e.g., the entities 109a and 109b) are accessed from the database 107 via the communication interface 105a. The communication interface 105a transmits the set of data and the set of attributes to the processing module 105b.

At step 303, the set of data and the set of attributes are inputted to the rule module 201. The set of data comprises an entity name, an entity type, an entity strength, an entity location, and a set of entity services and products of each corresponding pair of entities 109a and 109b. The set of attributes comprises one or more values of each of the set of data. An example of the set of data and the set of attributes is shown in FIG. 4.

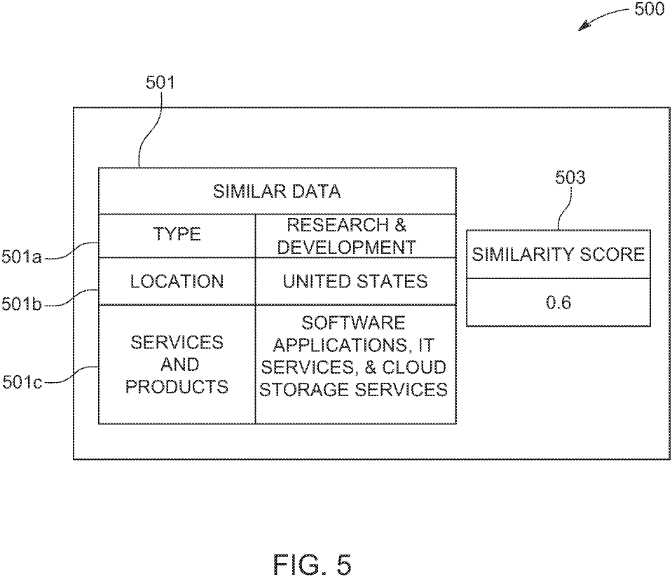

At step 305, the rule module 201 that comprises the rule-based model determines one or more similar data in the set of data of the pair of entities 109a and 109b. The one or more similar data are determined based on one or more similar attributes in the corresponding set of attributes of the pair of entities 109a and 109b. The rule module 201 also determines a similarity score based on the determined one or more similar data. The similarity score is a numerical value that represents a similarity measure describing closeness of each data in the set of data to each other. The similarity score ranges between 0 meaning low similarity and 1 meaning high similarity between the data of the entities 109a and 109b. The rule module 201 may calculate the similarity score using distance functions, such as Euclidean distance, Squared Euclidean distance, Manhattan distance, Lp-norm distance, Cosine distance, Jaccard distance or the like. An example of the one or more similar data and the similarity identifying the similarity between the entities 109a and 109b, is described in FIG. 5.

Then at step 307, a verification of the one or more similar data and the similarity score is performed. In some embodiments, the verification is performed based on a manual verification. For instance, the one or more similar data may be manually verified by a user, such as a developer. The developer may check if the determined one or more similar data are similar or not using a verification tool. For instance, the developer may access an application interface of the data management platform 105 in the computing system 101. In the application interface, the one or more similar data and the similarity score for the entities 109a and 109b may be displayed to the developer.

If there is dissimilarity in at least the one or more similar data and the similarity score, then at step 307a, one or more incorrect data that correspond to the dissimilarity are determined based on the manual verification. The dissimilar data may be corrected at step 307b, based on one or more user inputs for correction of the one or more incorrect data. The correction may include discarding the one or more incorrect data and checking for other similar data in the set of the data. The corrected one or more similar data are inputted to the rule module 201. At step 307c, the rule-based model of the rule module 201 is updated based on the correction. After step 307c, the control loops back to step 307 and proceeds to step 309.

At step 309, a collaborative pair for the entities 109a and 109b is generated by the collaborative filtering module 203 upon successful verification of the one or more similar data and the similarity score. The collaborative pair may be a similar data, such as similar entity type of the two entities, a similar relationship corresponding to a user entity associated to each of the two entities, or the like. The collaborative pair and the similarity score are inputted to the embedding module 205.

Further, at step 311, one or more embeddings that encode the collaborative pair and the similarity score in a vector space are generated by the embedding module 205. The method 300 ends at step 313.

The above-mentioned set of data and the set of attributes for the entities 109a and 109b that are processed by the processing module 105b using the rule module 201, the collaborative filtering module 203 and the embedding module 205, are described and shown in FIG. 4.

FIG. 4 illustrates a tabular representation 400 depicting a set of data and corresponding set of attributes for a pair of entities 109a and 109b, in accordance with one or more example embodiments. The set of data comprising an entity name, an entity type, an entity strength, an entity location, and a set of entity services and products of each corresponding pair of entities 109a and 109b and the set of attributes comprising one or more values of each of the set of data are shown in corresponding table 401 and table 403 of the entities 109a and 109b.

The table 401 includes data and attributes for the entity 109a, such as a name data 401a with an attribute “COMPANY A”, a type data 401b with an attribute “RESEARCH & DEVELOPMENT”, a strength data 401c with an attribute “500-1000”, a location data 401d with an attribute “UNITED STATES”, and a services and products data 401e with one or more attributes “SOFTWARE APPLICATIONS, IT SERVICES, & CLOUD STORAGE SERVICES”, as shown in table 301. In a similar manner, the table 403 includes data and attributes for the entity 109b, such as name data 403a with an attribute “COMPANY B”, a type data 403b with an attribute “RESEARCH & DEVELOPMENT”, a strength data 403c with an attribute “100-500”, a location data 403d with an attribute “UNITED STATES”, and a services and products data 403e with one or more attributes “SOFTWARE APPLICATIONS, IT SERVICES, & CLOUD STORAGE SERVICES, as shown in table 403.

The set of data and the set of attributes in the table 401 and table 403 are inputted to the rule-based model of the rule module 201 to identify one or more similar data based on similar attributes. For instance, the one or more similar data may include the type data 401b of the entity 109a and the type data 403b of the entity 109b, the location data 401d of the entity 109a and the location data 403d of the entity 109b and the services and products data 401e of the entity 109a and the services and products data 404e of the entity 109b. Each of the one or more similar data include the corresponding similar attribute. For instance, the type data 401b of the entity 109a and the type data 403b of the entity 109b have same attribute “RESEARCH & DEVELOPMENT”, the location data 401d of the entity 109a and the location data 403d of the entity 109b have same attribute “UNITED STATES” and the services and products data 401e of the entity 109a and the services and products data 404e of the entity 109b have same attribute “SOFTWARE APPLICATIONS, IT SERVICES, & CLOUD STORAGE SERVICES”, as shown in FIG. 4.

The identified one or more similar data and the similarity score for the entities 109a and 109b are shown in FIG. 5.

FIG. 5 illustrates a tabular representation 500 depicting one or more similar data, collectively referred to as similar data 501 and a similarity score 503 for the pair of entities 109a and 109b, in accordance with one or more example embodiments. The similar data 501 and the similarity score 503 are determined by the rule module 201, as described in step 301 of FIG. 3A.

The similar data 501 includes type data 501a with similar attribute “RESEARCH & DEVELOPMENT”, location data 501b with attribute “UNITED STATES” and services and products data 501c with attributes “SOFTWARE APPLICATIONS, IT SERVICES & CLOUD STORAGE SERVICES”. The similarity score 503 for the entities 109a and 109b is computed as “0.6” by the rule module 201. For instance, rule module 201 may compute the similarity score 503 by summing a total number of identified similar data, i.e., “3” and dividing the sum of the total number of identified similar data by total number of data, i.e., “5” to obtain the similarity score 503, i.e., “0.6”. In some embodiments, the rule module 201 may compute the similarity score 503 using distance functions, such as Euclidean distance, Squared Euclidean distance, Manhattan distance, Lp-norm distance, Cosine distance, Jaccard distance or the like.

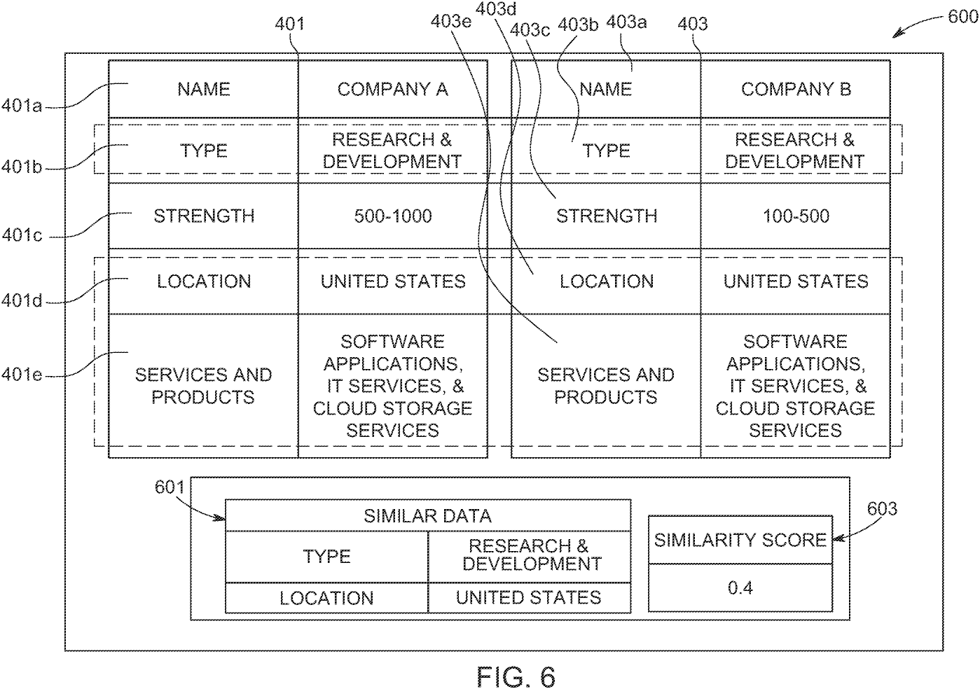

The above similar data 501 and the similarity score 503 are verified, which is further described in FIG. 6

FIG. 6 illustrates a graphical user interface (GUI) 600 depicting a verification of the one or more similar data, such as the similar data 501 and the similarity score, such as the similarity score 503, in accordance with one or more example embodiments. The GUI 600 may correspond to an application interface of the data management platform 105 be displayed via the computing system 101 to a developer for performing the verification of the similar data 501 and the similarity score 503. The verification of the similar data 501 and the similarity score 503 may be performed using a verification tool.

For the verification of the similar data 501 and the similarity score 503, the table 401 and table 403 may be accessed. The table 401 and 403 display the set of data and the corresponding set of attributes for the pair of entities 109a and 109b. The verification is performed based on a manual verification. For instance, a developer verifies the similar data 501 by checking the set of data and the set of attributes in the table 401 and 403. The developer may identify that services and products data 401e of table 401 and services and products of data 403e of table 403 are dissimilar as corresponding attributes are dissimilar. The dissimilarity in the similar data 501 is determined as incorrect data based on the manual verification by the developer. The incorrect data in the similar data 501 may be corrected based on user inputs of the developer. For instance, the developer may enter inputs, such as removal of the incorrect data from the similar data 501 via the application interface of the data management platform 105 in the computation system 101. The user inputs are received by the communication interface 105c and transmitted to the processing module 105b of the data management platform 105. The processing module 105 performs a correction of the similar data 501 to output a corrected similar data, such as similar data 601. The similarity score 503 is also corrected into a similarity score 603 based on the correction. For instance, the similarity score 503 (i.e., “0.6”) is corrected as the similarity score 603 with value “0.4”. The similarity score 603 may be computed by dividing sum of the total number of similar data (i.e., 2 similar data) by total number of data (i.e., 5), which outputs 0.4 as the similarity score 603. Further, the similar data 601 and the similarity score 603 may be used to update to the rule-based model of the rule module 201, as described in step 307c of FIG. 3B. To that end, the processing module 105b may transmit the corrected similarity data 601 and the similarity score 603 to the rule module 201 and update the rule-based model based on the corrected similarity data 601 and the similarity score 603.

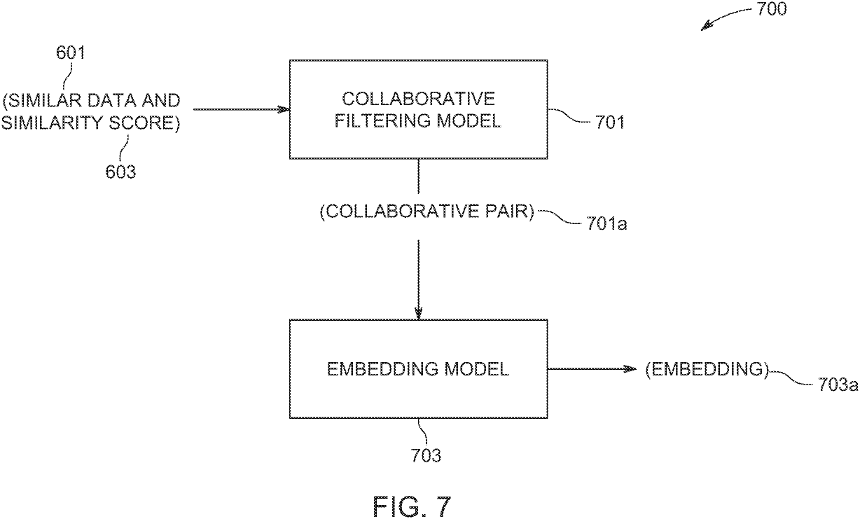

Furthermore, the similar data 601 and the similarity score 603 that identify the similarity between the pair of entities 109a and 109b are inputted to the collaborative filtering module 203. The collaborative filtering module 203 generates a collaborative pair for the pair of entities based on the similar data 601 and the similarity score 603, which is described next in FIG. 7.

FIG. 7 illustrates a schematic block diagram 700 for generating one or more embeddings by the embedding module 205, in accordance with one or more example embodiments. As mentioned earlier in step 309, one or more similar data and similarity score generated by the rule module 201, such as the similar data 601 and the similarity score 603 are inputted to a collaborative filtering model 701 of the collaborative filtering module 203.

The collaborative filtering model 701 uses the similar data 601 and the similarity score 603 to generate a collaborative pair 701a for the entities 109a and 109b. In some example embodiments, the collaborative pair 701a corresponds to at least one of a similar relationship corresponding to a user entity of each of the pair of entities 109a and 109b, and a similar entity type of the pair of entities 109a and 109b. For instance, the user entity may include an employee that has past employment in one entity of the pair of entities 109a and 109b and currently employed in other entity of the pair of entities. The similar entity type may correspond to one of fields of a company entity, such as research & development, manufacturing, sales, and distribution, and/or the like.

Further, the collaborative pair 701a is inputted to an embedding model 703 of the embedding module 205. In some example embodiments, the embedding model 703 may be trained based on the generated collaborative pair 601 and the similarity score 603. The embedding model 703 may include at least one of a word2vec model, and a two-tower deep learning model.

The embedding model 703 generates one or more embeddings 703a for the entities 109a and 109b. The embeddings 703a correspond to low-dimensional representations of discrete data of the collaborative pair as continuous vectors. Each of the embeddings 703 is a mapping of word/phrases corresponding to the collaborative pair 701a to a vector space of continuous vectors. The generated embeddings 703 may be stored in the database 107.

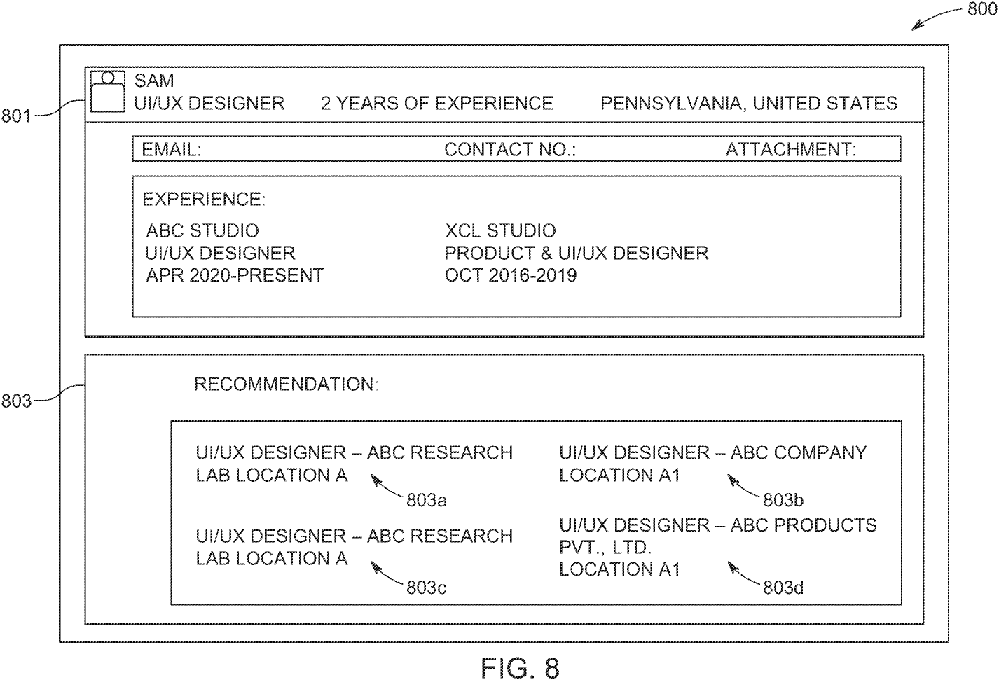

Furthermore, the embeddings 703a may be used for a recommendation response of a job recruitment task for a user profile data, which is described next with reference to FIG. 8.

FIG. 8 illustrates a GUI 800 depicting a user profile data 801 and a recommendation response 703 for a job recruitment task, in accordance with one or more example embodiments. The user profile data 801 may be received from a customer of the data management platform 105. In some cases, the customer may access an application interface of the data management platform 105 using the computing system 101 and upload the user profile data 801 to the data management platform 105. In some other cases, a recruiter may access the user profile data 801 from the database 107 via the application interface of the data management platform 105 using the computation system 101.

The user profile data 801 may include career related information associated with a user, such as a job candidate, a job seeker, or the like. The career related information may include a username, a designation, an email address, a contact number, an attachment file, an experience history, or the like.

The user profile data 801 may be received by the communication interface 105a of the data management platform 105. The communication interface 105a transmits the user profile data 801 to the processing module 105b. The processing module 105b determines a matching embedding from one or more embeddings stored in the database 107, such as the embeddings 703a for the user profile data 801. After determining the matching embedding, the processing module 105b generates a recommendation response 803. The recommendation response 803 comprises one or more entities, such as entity 803a, entity 803b, entity 803c and entity 803d. The entities 803a-803d are similar company entities with similar company type, at similar location, as shown in FIG. 8.

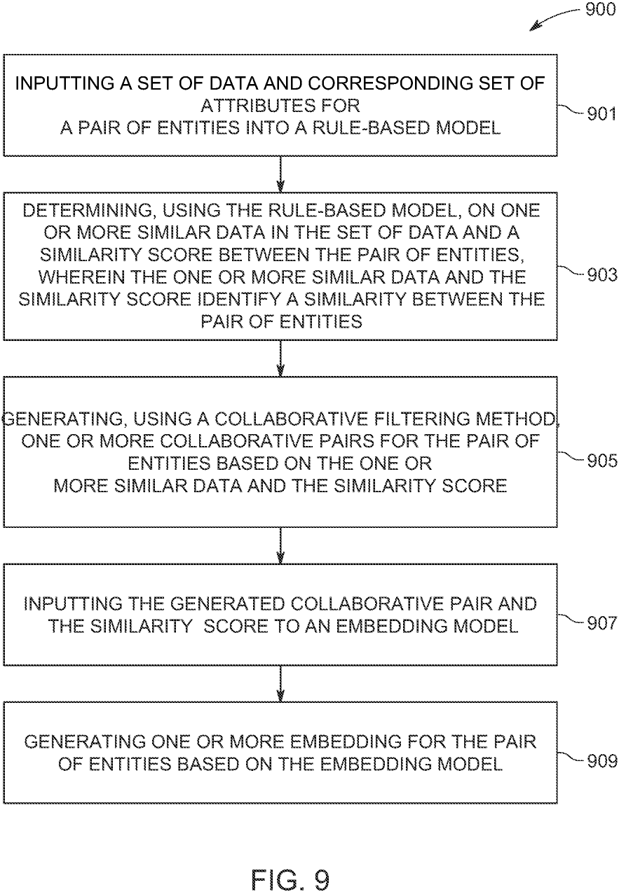

FIG. 9 illustrates a method flow 900 diagram for generating one or more embeddings of one or more entities, in accordance with one or more example embodiments

In some embodiments, each operation described in each block of the method 900 may be implemented in the form of computer-executable instructions, which are stored in a memory, such as the storage 105c associated with the data management platform 105. Further, the computer-executable instructions when executed, cause the various operations of the method 900 to be performed by at least one processor, such as the processing module 105b associated with the data management platform 105. For example, the processing module 105b may be configured to carry out the operation for the generation of one or more embeddings of one or more entities.

The method 900 includes, at step 901, carrying out computer-executable instructions for inputting a set of data and corresponding set of attributes for a pair of entities into a rule-based model. The set of data comprises an entity name, an entity type, an entity strength, an entity location, and a set of entity services and products of each corresponding pair of entities. The set of attributes comprises one or more values of each of the set of data. An example of the set of data and the set of attributes is shown in FIG. 4. The rule-based model corresponds to the rule module 201.

At step 903, using the rule-based model, one or more similar data (e.g., the similar data 501) in the set of data and a similarity score (e.g., the similarity score 503) for the pair of entities are determined based on corresponding one or more attributes of the one or more similar data. The one or more similar data and the similarity score identify a similarity between the pair of entities (described in FIG. 5). In some embodiments, the determined one or more similar data and the similarity score are verified based on a manual verification. The manual verification may be performed by a developer using a verification tool. In some cases, one or more incorrect data may be determined in the identified one or more similar data and the similarity score based on the manual verification. The one or more incorrect data correspond to dissimilarity in a least the one or more similar data and the similarity score. For instance, there may be dissimilar data in the identified similar data. The developer may provide inputs to perform a correction of the incorrect data in the similar data. For instance, the user may provide inputs to remove the dissimilar data in the identified similar data. The similarity score may also be corrected based on the correction of the incorrect data (refer FIG. 6).

At step 905, using a collaborative filtering model, (e.g., the collaborative filtering model 701), a collaborative pair (e.g., the collaborative pair 701a) for the pair of entities based on the one or more similar data and the similarity score. The collaborative pair for the pair of entities corresponds to at least one of a similar relationship corresponding to a user entity of each of the pair of entities, and a similar entity type of the pair of entities. The similar relationship and the similar entity type are generated from the one or more similar data and the similarity score using the collaborative filtering model.

Further, at step 907, the generated collaborative pair and the similarity score are inputted to an embedding model, such as the embedding model 703. In some example embodiments, the embedding model is trained based on the generated collaborative pair and the similarity score. The embedding model may include at least one of a word2vec model and a two-tower deep learning model.

Furthermore, at step 909, one or more embeddings, such as the embeddings 703a are generated based on the embedding model. The one or more embeddings may be used for a recommendation response for a job recruitment task. For instance, a user profile data (e.g., the user profile data 801 of FIG. 8) may be received for the job recruitment task. A matching embedding may be determined from the one or more embeddings for the user profile data. After determining the matching embedding, the recommendation response that includes one or more entities (e.g., the entities 803a-803d of FIG. 8) is generated for the user profile data.

In this manner, the data management platform 105 ensures generating embedding for one or more entities, such as customers of the data management platform 105 in an efficient, and feasible manner, without requiring too much memory resources. The embedding also improves efficiency of a hiring process. A user can access the services of the data management platform 105 described in all the previous embodiments by using their computing system 101, which is described in FIG. 10 below.

FIG. 10 illustrates a block diagram of the computing system 101 used for implementation of the system discussed in previous figures for accessing the services of the data management platform 105, in accordance with one or more example embodiments.

The computing system 101 includes an input interface 101a, at least one processor 101b, a memory 101c, an output interface 101a, and a network interface controller 101e, all components being interconnected by a bus for passing information.

The processor 101b executes computer-executable instructions, such as for accessing the data management platform 105 via one or more Application Programming Interface (API) calls, or via one or more network communication protocol messages. The processor 101b can include a general-purpose processor, a special-purpose processor, and combinations thereof. For example, the processor 101b can include a general-purpose central processing unit (CPU), a graphics processor, a processor in an application-specific integrated circuit (ASIC), a processor configured to operate using programmable logic (such as in a field-programmable gate array (FPGA)), and/or any other type of processor. In a multi-processing system, multiple processing units can be used to execute computer-executable instructions to increase processing power.

The memory 101c stores software implementing one or more innovations described herein, in the form of computer-executable instructions suitable for execution by the processor 101b. Specifically, the memory 101c can be used to store computer-executable instructions, data structures, input data, output data, and other information. The memory 101c can include volatile memory (e.g., registers, cache, random-access memory (RAM)), non-volatile memory (e.g., read-only memory (ROM), electrically erasable programmable ROM (EEPROM), and flash memory), and/or combinations thereof. The memory 101c can include operating system software (not illustrated). Operating system software can provide an operating environment for other software executing in the computing system 101 and can coordinate activities of the components of the computing system 101.

The computing system 101 may additionally include storage (not shown separately) that can include electronic circuitry for reading and/or writing to removable or non-removable storage media using magnetic, optical, or other reading and writing system that is coupled to the processor 101b. The storage can include read-only storage media and/or readable and writeable storage media, such as magnetic disks, solid state drives, magnetic tapes or cassettes, CD-ROMs, CD-RWs, DVDs, or any other medium which can be used to store information and that can be accessed within the computing system 101.

The computing system 101 may include the network interface controller 101e for communicating with another computing entity using a communication medium (e.g., the network 103 shown in FIG. 1).

The computing system 101 may include the input interface 101a for interfacing with and receiving input signals from input device(s) from a physical environment. The input device(s) can include a tactile input device (e.g., a keyboard, a mouse, or a touchscreen), a microphone, a camera, a sensor, or another device that provides input to the computing system 101.

The computing system 101 may include the output interface 101d to provide an output interface to a user of the computing system 101 and/or to generate an output observable in a physical environment using output device(s). The output device(s) can include a light-emitting diode, a display, a printer, a speaker, a CD-writer, or another device that provides output from the computing system 101. In some examples, the input device(s) and the output device(s) may be used together to provide a user interface to a user of the computing system 101.

The computing system 101 is not intended to suggest limitations as to scope of use or functionality of the technology, as the technology can be implemented in diverse general-purpose and/or special-purpose computing environments. For example, the disclosed technology can be practiced in a local, distributed, and/or network-enabled computing environment. In distributed computing environments, tasks are performed by multiple processing devices. Accordingly, principles and advantages of distributed processing, such as redundancy, parallelization, and replication also can be implemented, as desired, to increase the robustness and performance of the devices and systems of the examples. The examples may also be implemented on computer system(s) that extend across any suitable network using any suitable interface mechanisms and traffic technologies, including by way of example only, wireless traffic networks, cellular traffic networks, Packet Data Networks (PDNs), the Internet, intranets, and combinations thereof.

The term computer-readable media includes non-transient media for data storage, such as memory 101c and storage 105c (shown in FIG. 2) and does not include transmission media such as modulated data signals and carrier waves. Any of the disclosed methods can be implemented as computer-executable instructions stored on one or more computer-readable media and executed on a computer (e.g., any commercially available computer). Any of the computer-executable instructions for implementing the disclosed techniques as well as any data structures and data created and used during implementation of the disclosed embodiments can be stored on one or more computer-readable storage media. For example, the computer-executable instructions can be part of a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network, or other such network) using one or more network-attached computers.

Accordingly, blocks of the methods shown by flow diagrams support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. A computer-implemented method for generating one or more embeddings of one or more entities, comprising:
inputting a set of data and corresponding set of attributes for a pair of entities into a rule-based model;
determining, using the rule-based model, one or more similar data in the set of data and a similarity score for the pair of entities based on corresponding one or more attributes of the one or more similar data, wherein the one or more similar data and the similarity score identify a similarity between the pair of entities;
generating, using a collaborative filtering model, a collaborative pair for the pair of entities based on the one or more similar data and the similarity score;
inputting the generated collaborative pair and the similarity score to an embedding model; and
generating one or more embeddings for the pair of entities based on the embedding model.

2. The method of claim 1, wherein the set of data comprises: an entity name, an entity type, an entity strength, an entity location, and a set of entity services and products of each corresponding pair of entities, and the set of attributes comprises one or more values of each of the set of data.

3. The method of claim 1, wherein generating the collaborative pair comprises:
performing a verification of the one or more similar data and the similarity score based on a manual verification; and
generating the collaborative pair upon successful verification of the one or more similar data and the similarity score.

4. The method of claim 3, further comprises:
determining one or more incorrect data in the one or more similar data and the similarity score based on the manual verification, wherein the one or more incorrect data correspond to a dissimilarity in at least the one or more similar data and the similarity score;
receiving corresponding one or more user inputs for correction of the one or more incorrect data; and
updating the rule-based model based on the correction.

5. The method of claim 1, wherein inputting the generated collaborative pair further comprises:
training the embedding model based on the generated collaborative pair and the similarity score.

6. The method of claim 1, wherein the collaborative pair for the pair of entities corresponds to at least one of a similar relationship corresponding to a user entity of each of the pair of entities, and a similar entity type of the pair of entities, wherein the similar relationship and the similar entity type are generated from the one or more similar data and the similarity score using the collaborative filtering model.

7. The method of claim 1, wherein the embedding model comprises at least one of a word2vec embedding model, and a two-tower deep learning model.

8. The method of claim 1, further comprising:
receiving user profile data for a job recruitment task;
determining a matching embedding from the one or more embeddings for the user profile data; and
generating a recommendation response comprising the one or more entities based on the determined matching embedding.

9. A system for generating one or more embeddings of one or more entities, comprising:
a memory configured to store one or more computer-executable instructions; and
at least one processor configured to execute the one or more computer-executable instructions to:
input a set of data and corresponding set of attributes for a pair of entities into a rule-based model;
determine, using the rule-based model, one or more similar data in the set of data and a similarity score for the pair of entities based on corresponding one or more attributes of the one or more similar data, wherein the one or more similar data and the similarity score identify a similarity between the pair of entities;
generate, using a collaborative filtering model, a collaborative pair for the pair of entities based on the one or more similar data and the similarity score;
input the generated collaborative pair and the similarity score to an embedding model; and
generate one or more embeddings for the pair of entities based on the embedding model.

10. The system of claim 9, wherein the set of data comprises: an entity name, an entity type, an entity strength, an entity location, and a set of entity services and products of each corresponding pair of entities, and the set of attributes comprises one or more values of each of the set of data.

11. The method of claim 9, wherein for generating the collaborative pair, the at least one processor is further configured to execute the one or more computer-executable instructions to:
perform a verification of the one or more similar data and the similarity score based on a manual verification; and
generate the collaborative pair upon successful verification of the one or more similar data and the similarity score.

12. The system of claim 11, wherein the at least one processor is further configured to execute the one or more computer-executable instructions to:
determine one or more incorrect data in the one or more similar data and the similarity score based on the manual verification, wherein the one or more incorrect data correspond to a dissimilarity in at least the one or more similar data and the similarity score;
receive corresponding one or more user inputs for correction of the one or more incorrect data; and
update the rule-based model based on the correction.

13. The system of claim 9, wherein for inputting the generated collaborative pair, the at least one processor is further configured to execute the one or more computer-executable instructions to train the embedding model based on the generated collaborative pair and the similarity score.

14. The system of claim 9, wherein the collaborative pair for the pair of entities corresponds to at least one of a similar relationship corresponding to a user entity of each of the pair of entities, and a similar entity type of the pair of entities, wherein the similar relationship and the similar entity type are generated from the one or more similar data and the similarity score using the collaborative filtering model.

15. The system of claim 9, wherein the embedding model comprises at least one of a word2vec embedding model, and a two-tower deep learning model.

16. The system of claim 9, wherein the at least one processor is further configured to execute the one or more computer-executable instructions to:
receive a user profile data for a job recruitment task;
determine a matching embedding from the one or more embeddings for the user profile data; and
generate a recommendation response comprising one or more entities based on the determined matching embedding.

17. A computer program stored on a non-transitory computer readable medium, the computer program are configured to cause the one or more processors to perform operations for generating one or more embeddings of one or more entities, the operations comprising:
inputting a set of data and corresponding set of attributes for a pair of entities into a rule-based model;
determining, using the rule-based model, one or more similar data in the set of data and a similarity score for the pair of entities based on corresponding one or more attributes of the one or more similar data, wherein the one or more similar data and the similarity score identify a similarity between the pair of entities;
generating, using a collaborative filtering model, a collaborative pair for the pair of entities based on the one or more similar data and the similarity score;
inputting the generated collaborative pair and the similarity score to an embedding model; and
generating one or more embeddings for the pair of entities based on the embedding model.

18. The computer program product of claim 17, wherein for generating the collaborative pair, the operations further comprise:
performing a verification of the one or more similar data and the similarity score based on a manual verification; and
generating the collaborative pair upon successful verification of the one or more similar data and the similarity score.

19. The computer program product of claim 18, wherein the operations further comprise:
determining one or more incorrect data in the one or more similar data and the similarity score based on the manual verification, wherein the one or more incorrect data correspond to a dissimilarity in at least the one or more similar data and the similarity score;
receiving corresponding one or more user inputs for correction of the one or more incorrect data; and
updating the rule-based model based on the correction.

20. The computer program product of claim 17, wherein for inputting of the generated collaborative pair, the operations further comprise training the embedding model based on the generated collaborative pair and the similarity score.
